(19) United States
(12) Patent Application Publication
(10) Pub. No.: US 2015/0201741 A1
(43) Pub. Date: Jul. 23, 2015

(54) STRAP SECURING PIECE

(71) Applicant: Young Sun KIM, (US)

(72) Inventor: Young Sun Kim, Gunsan-si (KR)

(21) Appl. No.: 14/414,443

(22) PCT Filed: Jul. 12, 2013
(86) PCT No.: PCT/KR2013/006271

§ 371 Date: Jan. 12, 2015

(30) Foreign Application Priority Data
Jul. 13, 2012 (KR) 20-2012-0006187

(51) Int. Cl. A45F 5/00; H04M 1/04

(52) U.S. Cl. CPC A45F 5/00; H04M 1/04; A45F 2005/006

(57) ABSTRACT

The present invention relates to a securing piece for securing a thin article to be secured, such as a hand strap (band) to a smartphone device back surface. The present invention involves the formation of a flexible metal securing plate (1) and two facing strap raised holes (3) in the securing plate, and comprised in a part inside each strap raised hole (3) there is an extending securing section (5), and a fastening part (7) is formed in the end of each securing section (5). The present invention is directly used in a back-surface cover of a smartphone device, while it is also possible to use a separate mounting plate (20) formed so as to have securing recesses (50) where the securing sections (5) are inserted and accommodated.

### Field of the Invention

The present invention relates to a securing piece for securing a thin article to be secured, such as a hand strap (band) to a smartphone device back surface.

### BACKGROUND ART

The present invention has been developed as a means for securing a band (belt)-type handle, which corresponds to this patent invention, during a process of commercializing the registered patent No. 10-1097649 (Handle structure of a mobile terminal device) of the applicant.

In this invention, a handle being mounted on a back surface of a mobile terminal device is secured by using a method of inserting both ends of a belt-type handle into securing holes (or recesses), which are formed in parallel to form the shape of number 11 on the back surface of the device, and then being adhered to the back surface of the device.

However, in order to allow consumers to more easily apply this invention to their devices, it was highly preferable to distribute this invention by securing both ends of the strap, which corresponds to a handle band, to a separate mounting plate, and by depositing an adhesive on a surface of the mounting plate and then adhering a protective (film) sticker thereon.

Accordingly, the inventor of this invention has researched and tested a securing piece that can secure the handle strap onto the mounting plate and that has an excellent workability while having a thin securing part and a robust securing force, and, as a result, the inventor has come to achieve the present invention.

### DETAILED DESCRIPTION OF THE INVENTION

### Technical Objects

An object of the present invention is to provide a securing piece that can secure a strap on the surface of a device by using a simple structure.

Another object of the present invention is to provide a simple securing piece having excellent workability and a strong securing force.

### Technical Solutions

An object of the present invention is to provide a strap securing piece including a flexible metal securing plate (1) and strap raised holes (3) being formed on the securing plate, and wherein an extending securing section (5) extending from a portion of an inner side of the strap raised holes is included.

If a fastening part (7) is formed on the securing section (5), the workability may be remarkably enhanced.

In the present invention, if a tooling groove (11) is formed on the securing plate (1), the securing plate may be prevented from being easily bent.

By forming bent parts (9, 9′) on side sides or rear (or back) sides of the securing plate (1), a cross-sectional surface of the secured strap may be protected or the finishing of the product may be enhanced.

In the present invention, it will be preferable to use a mounting plate (20) having securing recesses (50) formed thereon, wherein the securing recesses (50) have the securing section (5) of the securing plate (1) inserted and accommodated therein.

The securing recesses (50) are provided with fitting holes (55), wherein a front surface is formed to be protruded and a back surface is formed to be dented, so as to allow the securing section (5) to be bent and accommodated therein.

### Effects of the Invention

According to the present invention, a simple strap securing piece having a strong securing force and excellent operability is provided.

If a fastening part is formed at an end of a securing section of the present invention, a fastening tool is prevented from slipping when securing the strap, thereby highly enhancing its workability.

If a securing plate and a mounting plate of the present invention are used by securing a smartphone hand strap in advance, and by depositing an adhesive on a back surface of the mounting plate and, then, mounting a protective film on the deposited adhesive, the securing plate and the mounting plate of the present invention may be distributed as a product that can be directly applied to a device by the user.

### BRIEF DESCRIPTION OF THE DRAWINGS

FIG. 1 illustrates a perspective view of a securing piece corresponding to an exemplary embodiment of the present invention.

FIG. 2 illustrates an exemplary varied embodiment of FIG. 1.

FIG. 3 illustrates a combined structure of the present invention and the strap.

FIG. 4 illustrates a plane view seen from above after the combination shown in FIG. 3.

FIG. 5 illustrates a backside view of FIG. 4.

### MODE FOR CARRYING OUT THE PRESENT INVENTION

Details of the present invention will be more clarified by the description that will hereinafter be made with reference to the accompanying drawings.

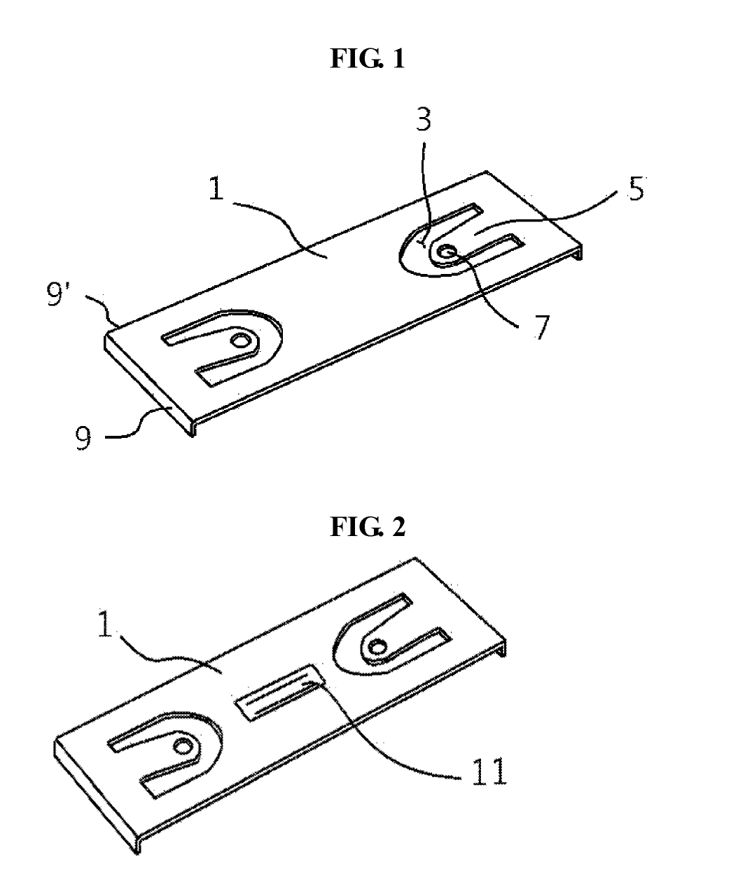

FIG. 1 illustrates a basic configuration of the present invention. As shown in the drawing, a basic configuration of the preset invention is formed as a single body on a quadrangular metal securing plate (1), which corresponds to a main body.

The securing plate (1) has one strap raised hole (3) formed near each end of the securing plate (1) so as to face into one another, and a securing section (5) is formed as a protrusion protruding from one end of an inner side of the strap raised hole (3).

According to an exemplary embodiment, although two strap raised holes (3) and securing sections (5) are formed simultaneously by punching the securing plate (1) with a metallic mold having the shape of “⊃ ⊂”, the strap raised holes (3) having securing sections (5) formed therein are not necessarily limited to two strap raised holes (3), and, therefore, one or more strap raised holes (3) will be sufficient, and the respective form may also be diversely varied.

A fastening part (7) formed on an end each end portion of the securing sections (5) of FIG. 1 is formed to allow a fastening force to be applied thereto, when a tool, such as a pair of pliers, is caught therein during a process of securing the strap. In this exemplary embodiment, although the fastening part (7) is formed to have the form of a circular (or round) hole, the hole may be formed to have any shape as long as a force of a working tool can be applied thereto, and, also, the shape of the hole will not by limited only to this exemplary embodiment.

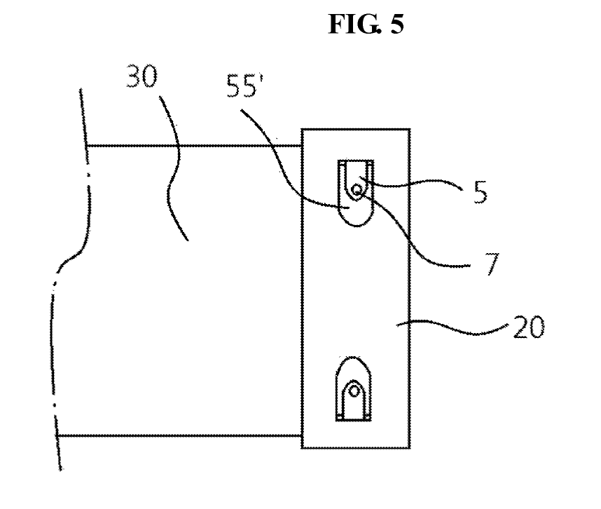

Non-described reference numerals 9 and 9′ correspond to bent parts (9, 9′), which correspond to protrusions that are formed in a bent shape at an edge portion of a lateral side and an edge portion of a back side of the securing plate. More specifically, by enveloping an end cross-sectional surface and a side cross-sectional surface of the strap, which is combined with the securing plate (1), a finishing function of the securing area becomes excellent, and the form of the securing plate, which is formed as a thin metal plate, may be maintained, thereby performing a function of preventing the shape of the securing plate (1) from being deformed (or varied). (See FIG. 4.)

FIG. 2 illustrates a tooling groove (11) formed along a longitudinal direction of the securing plate (1). The tooling groove (11) is configured to reinforce a horizontal strength of the securing plate, thereby preventing the securing plate formed being bent (or curved). Accordingly, one or more tooling grooves (11) may be positioned on adequate locations by considering a substance of the securing plate, a bending strength, intervals between strap raised holes, and so on.

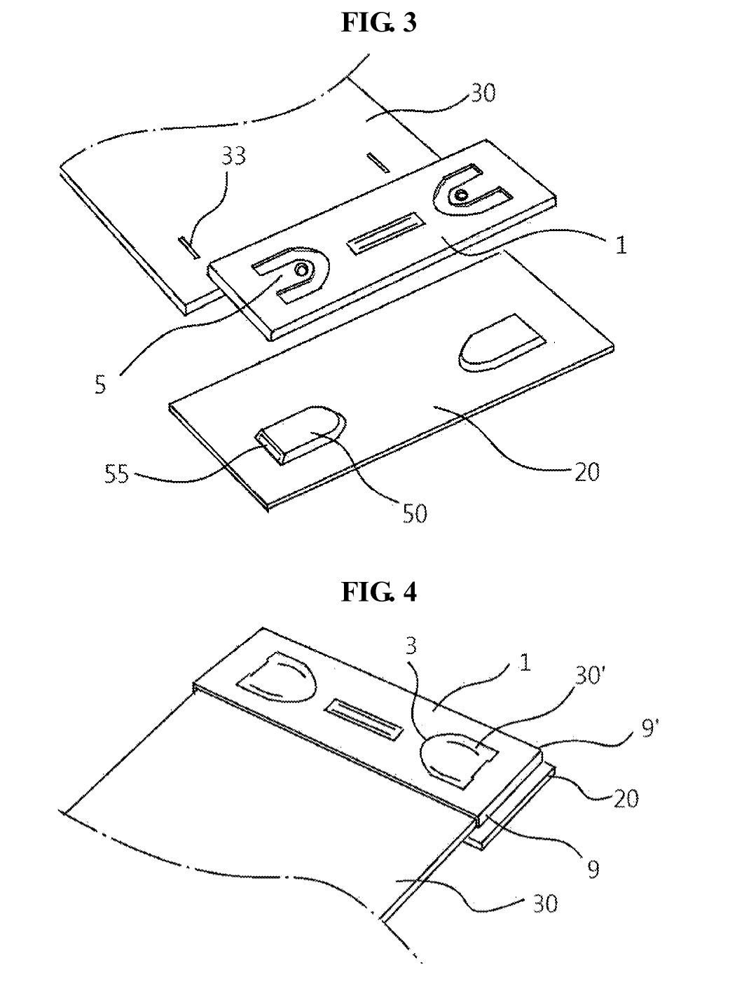

FIG. 3 illustrates a state of a strap (30) prior to being secured by the strap securing piece, which corresponds to the present invention. As shown in the drawing, one end of the strap (30) is placed between the securing plate (1) and a separate mounting plate (20), and the securing sections (5) of the securing plate are bent downward, so as to be fit into and to penetrate securing slits (30) of the strap, which are then inserted into fitting holes (55) of the mounting plate (20) and then bent at the back surface (55′ of FIG. 5) of the securing recesses.

During the bending process, when a fastening tool applies a fastening force by being caught in the fastening holes (7), the securing plate (1) and the mounting plate (20) become closely attached to one another, and since an upper surface (or front surface) (50) of the protruded securing recesses pushes the strap upward along the direction of the strap raised holes (3), the strap surface swells up to the strap raised holes (3), thereby forming raised parts (30′ of FIG. 4) and being securely fixed.

Therefore, by forming a slit (corresponding to 55 of the present invention) allowing the securing sections (5) to be directly inserted therein on a back surface cover of a smartphone, which is formed of a synthesized resin, and by inserting the securing sections (5) in such slits, and by fastening the securing sections (5) from the inside of the back surface cover of the smartphone, the present invention may be realized without using any mounting plate (20). In this case, it will be preferable that the rear surface cover of the smartphone has a predetermined level of elasticity, so that the strap can be raised through the strap raised holes (3).

FIG. 5 illustrates a rear surface of the mounting plate (20), when the strap (20) is in a state of being secured by the securing plate (1) and the mounting plate (20). Herein, although the securing recess back surfaces (55′) are formed to have the shape of dented grooves as a result of pressing on the metallic securing plate, so that the upper surface (or front surface) (50) of the securing recesses can be protruded, the dented form has another advantage.

For example, an adhesive is deposited on the rear surface of the mounting plate (20) so that the secured strap can be adhered to the device, and a protective film is attached to the adhesive so as to prevent the function of the adhesive from being damaged during the distribution process. At this point, since the securing section is accommodated in the securing recess back surface, a valid adhesive surface is ensured as much as possible even when the protective film is attached to the device without being damaged.

The scope of the present invention shall now be clarified with the description presented above. The details mentioned in this specification are merely presented to facilitate the understanding of the present invention, and, therefore, the details of this specification are not provided to limit the scope of the present invention to the exemplary embodiment presented herein. Therefore, although modifications and variations may be made on the above-described elements, it should be understood that such modifications and variations come within the scope of the appended claims of the present invention.

1. A strap securing piece, comprising:
a flexible metal securing plate (1) and strap raised holes (3) being formed on the securing plate, and wherein an extending securing section (5) extending from a portion of an inner side of the strap raised holes is included.

2. The strap securing piece of claim 1, wherein a fastening part (7) is formed on the securing section (5).

3. The strap securing piece of claim 1, wherein the securing plate (1) includes a tooling groove (11).

4. The strap securing piece of claim 1, wherein the securing plate (1) has bent parts (9, 9′) formed on each edge.

5. The strap securing piece of claim 1, further comprising:
a mounting plate (20) having securing recesses (50) formed thereon, wherein the securing recesses (50) have the securing section (5) inserted and accommodated therein

6. The strap securing piece of claim 5, wherein the securing recesses (50) are provided with fitting holes (55), and wherein a front surface is formed to be protruded and a back surface is formed to be dented, so as to allow the securing section (5) to be bent and accommodated therein.

7. The strap securing piece of claim 2, wherein the securing plate (1) includes a tooling groove (11).

8. The strap securing piece of claim 2, wherein the securing plate (1) has bent parts (9, 9′) formed on each edge.

9. The strap securing piece of claim 2, further comprising:
a mounting plate (20) having securing recesses (50) formed thereon, wherein the securing recesses (50) have the securing section (5) inserted and accommodated therein
